(19) United States
(12) Patent Application Publication
(10) Pub. No.: US 2025/0267463 A1
(43) Pub. Date: Aug. 21, 2025

(54) METHOD AND APPARATUS FOR DYNAMIC CHANNEL ALLOCATION

(71) Applicant: ELECTRONICS AND TELECOMMUNICATIONS RESEARCH INSTITUTE, Daejeon (KR)

(72) Inventor: Hee Wook KIM, Daejeon (KR)

(73) Assignee: ELECTRONICS AND TELECOMMUNICATIONS RESEARCH INSTITUTE, Daejeon (KR)

(21) Appl. No.: 19/020,476

(22) Filed: Jan. 14, 2025

(30) Foreign Application Priority Data
Feb. 20, 2024 (KR) 10-2024-0024637

(51) Int. Cl. H04W 16/10; H04B 17/345

(52) U.S. Cl. CPC H04W 16/10; H04B 17/345

(57) ABSTRACT

A method of a first communication node may comprise: receiving, from a second communication node, channel request information including information requesting one or more channels available for use by the second communication node and system information of the second communication node; performing interference analysis based on the channel request information and the system information; determining the one or more channels available for use by the second communication node based on a result of the interference analysis; determining a first channel to be allocated to the second communication node among the one or more available channels; and transmitting channel information including information on the first channel to the second communication node.

### CROSS-REFERENCE TO RELATED APPLICATIONS

This application claims priority to Korean Patent Application No. 10-2024-0024637, filed on Feb. 20, 2024, with the Korean Intellectual Property Office (KIPO), the entire contents of which are hereby incorporated by reference.

### BACKGROUND

### 1. Technical Field

The present disclosure relates to a technique for communication networks, and more particularly, to a technique for dynamic channel allocation in a three-dimensional multi-layered spatial communication network.

### 2. Related Art

A communication system may be assigned a channel for system operations. In conventional communication environments, when a specific system is operated under a Spectrum Authority (SA), a channel may be allocated on a fixed basis for a long period (e.g. over a year). In such cases, the channel once allocated to the specific system may be challenging to use for other systems.

Additionally, when a specific system operates cells, frequency channels may be fixedly assigned on a per-cell basis. Consequently, it may be difficult for the specific system to utilize a frequency of a cell with low traffic demand in cells with high traffic demand.

Furthermore, past communication networks, which primarily relied on terrestrial networks, may evolve into non-terrestrial and terrestrial integrated networks combining High Altitude Platform Stations (HAPS), satellite networks, and terrestrial networks. The satellite networks may develop into multi-layered networks utilizing low-Earth orbit (LEO), medium-Earth orbit (MEO), and geostationary orbit (GEO) satellites. Therefore, efficient frequency resource utilization technologies are essential in three-dimensional multi-layered communication networks.

### SUMMARY

The present disclosure for resolving the above-described problems is directed to providing a method and apparatus for dynamic channel allocation.

A method of a first communication node, according to a first exemplary embodiment of the present disclosure, may comprise: receiving, from a second communication node, channel request information including information requesting one or more channels available for use by the second communication node and system information of the second communication node; performing interference analysis based on the channel request information and the system information; determining the one or more channels available for use by the second communication node based on a result of the interference analysis; determining a first channel to be allocated to the second communication node among the one or more available channels; and transmitting channel information including information on the first channel to the second communication node.

The performing of the interference analysis may comprise: performing the interference analysis by comparing a channel of the second communication node and channels used in a network of the first communication node.

The performing of the interference analysis may comprise: calculating an undesired/desired signal ratio (U/D) value based on at least one of the system information of the second communication node, allocation criteria information including threshold(s), and existing channel information including information of channels used in a network of the first communication node; calculating a separation distance between the channel of the second communication node and the channels used in the network of the first communication node based on the U/D value; and performing the interference analysis based on the separation distance.

The determining of the one or more channels available for use by the second communication node may comprise: classifying channels used in a network of the first communication node into at least one of co-channel, adjacent channel, or non-adjacent channel, respectively, based on the result of the interference analysis; and determining the one or more channels available for use by the second communication node based on the classified channels.

The performing of the interference analysis may comprise: classifying the second communication node according to an altitude of the second communication node based on the system information; and performing the interference analysis with channels corresponding to the altitude of the second communication node among channels used in a network of the first communication node.

The determining of the one or more channels available for use by the second communication node may comprise: determining the one or more channels available for use by the second communication node, based on a ratio of a total network capacity of the first communication node to a network capacity corresponding to the altitude.

The determining of the one or more channels available for use by the second communication node may comprise: determining the one or more channels available for use by the second communication node in a fixed frequency channel resource section of the first communication node, the fixed frequency resource section being classified according to the altitude.

The determining of the one or more channels available for the second communication node may comprise: determining the one or more channels available for use by the second communication node in a neutral frequency channel resource section of the first communication node, the neutral frequency channel resource section being classified according to the altitude.

A method of a second communication node, according to a second exemplary embodiment of the present disclosure, may comprise: transmitting, to a first communication node, channel request information including information requesting one or more available channels and system information of the second communication node; receiving, from the first communication node, channel information generated based on the channel request information and the system information of the second communication node; and transmitting, to the first communication node, channel response information generated based on the channel information.

The channel information may include information on one or more channels determined based on a ratio of a total network capacity of the first communication node to a network capacity corresponding to an altitude of the second communication node.

The channel information may include information on one or more channels determined based on channels allocated in a fixed frequency resource section of the first communication node.

The channel information may include information on one or more channels determined based on channels allocated in a neutral frequency resource section of the first communication node.

A first communication node, according to a first exemplary embodiment of the present disclosure, may comprise: at least one processor, wherein the at least one processor may cause the first communication node to perform: receiving, from a second communication node, channel request information including information requesting one or more channels available for use by the second communication node and system information of the second communication node; performing interference analysis based on the channel request information and the system information; determining the one or more channels available for use by the second communication node based on a result of the interference analysis; determining a first channel to be allocated to the second communication node among the one or more available channels; and transmitting channel information including information on the first channel to the second communication node.

In the performing of the interference analysis, the at least one processor may cause the first communication node to perform: performing the interference analysis by comparing a channel of the second communication node and channels used in a network of the first communication node.

In the performing of the interference analysis, the at least one processor may cause the first communication node to perform: calculating an undesired/desired signal ratio (U/D) value based on at least one of the system information of the second communication node, allocation criteria information including threshold(s), and existing channel information including information of channels used in a network of the first communication node; calculating a separation distance between the channel of the second communication node and the channels used in the network of the first communication node based on the U/D value; and performing the interference analysis based on the separation distance.

In the determining of the one or more channels available for use by the second communication node, the at least one processor may cause the first communication node to perform: classifying channels used in a network of the first communication node into at least one of co-channel, adjacent channel, or non-adjacent channel, respectively, based on the result of the interference analysis; and determining the one or more channels available for use by the second communication node based on the classified channels.

In the performing of the interference analysis, the at least one processor may cause the first communication node to perform: classifying the second communication node according to an altitude of the second communication node based on the system information; and performing the interference analysis with channels corresponding to the altitude of the second communication node among channels used in a network of the first communication node.

In the determining of the one or more channels available for use by the second communication node, the at least one processor may cause the first communication node to perform: determining the one or more channels available for use by the second communication node, based on a ratio of a total network capacity of the first communication node to a network capacity corresponding to the altitude.

In the determining of the one or more channels available for use by the second communication node, the at least one processor may cause the first communication node to perform: determining the one or more channels available for use by the second communication node in a fixed frequency channel resource section of the first communication node, the fixed frequency resource section being classified according to the altitude.

In the determining of the one or more channels available for use by the second communication node, the at least one processor may cause the first communication node to perform: determining the one or more channels available for use by the second communication node in a neutral frequency channel resource section of the first communication node, the neutral frequency channel resource section being classified according to the altitude.

According to the present disclosure, it is made possible to efficiently operate various communication networks within a limited frequency band. Additionally, the present disclosure enables efficient utilization of communication frequency resources, allowing stable operations of various communication networks with limited frequency resources. The present disclosure facilitates efficient utilization of communication frequency resources, thereby expanding a capacity to meet the demands of various communication networks within limited frequency resources. Through this, the present disclosure can enhance the performance of the network.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart illustrating an exemplary embodiment of a channel allocation procedure.

FIG. 4 is a flow chart illustrating an exemplary embodiment of a dynamic channel allocation method.

FIG. 5 is a sequence chart illustrating an exemplary embodiment based on a frequency separation distance.

FIG. 6 is a conceptual diagram illustrating an exemplary embodiment of a frequency channel allocation method.

FIG. 7A is a conceptual diagram illustrating a first exemplary embodiment of a vertical division-based channel allocation method.

FIG. 7B is a conceptual diagram illustrating a second exemplary embodiment of a vertical division-based channel allocation method.

FIG. 8A is a conceptual diagram illustrating a third exemplary embodiment of a vertical division-based channel allocation method.

FIG. 8B is a conceptual diagram illustrating a fourth exemplary embodiment of a vertical division-based channel allocation method.

FIG. 8C is a conceptual diagram illustrating a fifth exemplary embodiment of a vertical division-based channel allocation method.

FIG. 8D is a conceptual diagram illustrating a sixth exemplary embodiment of a vertical division-based channel allocation method.

FIG. 9 is a flowchart illustrating a first exemplary embodiment of a vertical division method.

FIG. 10A is a flowchart illustrating a second exemplary embodiment of a vertical division method.

FIG. 10B is a flowchart illustrating a third exemplary embodiment of a vertical division method.

FIG. 10C is a flowchart illustrating a fourth exemplary embodiment of a vertical division method.

FIG. 10D is a flowchart illustrating a fifth exemplary embodiment of a vertical division method.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system or memory system to which exemplary embodiments of the present disclosure are applied will be described. The communication system or memory system to which the exemplary embodiments of the present disclosure are applied is not limited to the contents described below, and the exemplary embodiments of the present disclosure can be applied to various communication systems. Here, the term ‘communication system’ may be used interchangeably with ‘communication network’.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

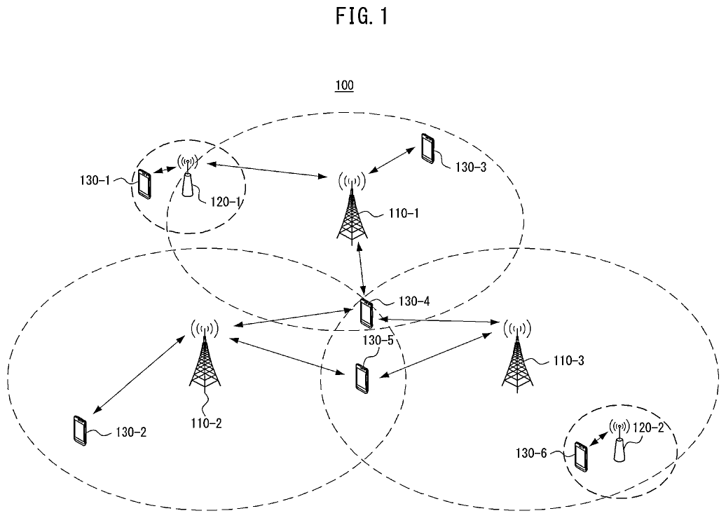

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHZ, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

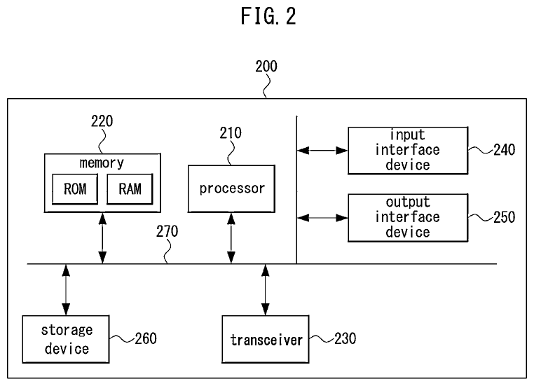

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

The present disclosure relates to methods of dynamically allocating frequency channels for frequency sharing in a three-dimensional multi-layered spatial network. The frequency sharing may occur within a network or between different networks. The disclosed methods enable efficient use of limited communication frequency resources. To use frequency resources efficiently, the disclosed methods may refrain from assigning communication frequency channels fixedly to a specific system, a specific cell, or a specific entity. The disclosed methods may allow for channel allocation through communication channel management by a Spectrum Authority (SA) or a network operator. The disclosed methods may dynamically allocate communication channels when there is a traffic demand. Furthermore, the disclosed methods may dynamically reclaim communication channels when there is a traffic demand. In addition, the present disclosure also proposes dynamic channel allocation methods to improve the efficiency of frequency usage in three-dimensional space. To further enhance frequency usage efficiency, the present disclosure proposes methods for analyzing dynamic interference in a three-dimensional spatial network. The present disclosure also proposes channel selection methods for improved frequency usage efficiency.

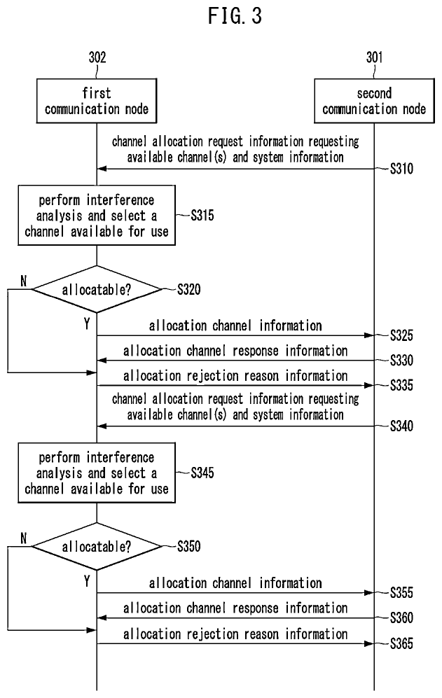

FIG. 3 is a sequence chart illustrating an exemplary embodiment of a channel allocation procedure.

Referring to FIG. 3, a channel allocation procedure may be performed in a three-dimensional multi-layered spatial network. The three-dimensional multi-layered spatial network may include at least one of the following: one or more terrestrial networks, one or more HAPS networks, one or more LEO networks, one or more MEO networks, or one or more GEO networks. Additionally, the three-dimensional multi-layered spatial network may include multiple networks in which transceivers of a base station are located variously within a three-dimensional space. Each network that constitutes the three-dimensional multi-layered spatial network may be referred to as a constituent network. The three-dimensional multi-layered spatial network may also be referred to as an integrated network.

The three-dimensional multi-layered spatial network (integrated network) may be operated by a single operator. Alternatively, the constituent networks constituting the three-dimensional multi-layered spatial network may be operated by different operators. Each constituent network may use a channel of the three-dimensional multi-layered spatial network. In this case, the constituent network may request frequency allocation from the three-dimensional multi-layered spatial network to use a channel of the integrated network. The three-dimensional multi-layered spatial network may perform a channel allocation procedure to allocate a channel to the constituent network. The channel allocation procedure may involve analyzing interference through a frequency allocation entity and assigning channels accordingly. The channel allocation procedure may use at least one of the following schemes: centralized channel allocation, distributed channel allocation, graph coloring-based channel allocation, or vertical frequency division-based channel allocation.

FIG. 3 may represent the centralized channel allocation scheme. The centralized channel allocation scheme may involve a frequency allocation entity searching for available channels.

For channel allocation, each constituent network may request frequency allocation through a network-specific frequency allocation request entity. The network-specific frequency allocation request entity may refer to a specific entity that requests a frequency channel to support a traffic required by each constituent network of the three-dimensional spatial network. The network-specific frequency allocation request entity may include a separate frequency allocation request server operated by an operator. The network-specific frequency allocation request entity may refer to a specific function of a core network or may refer to a base station of each network. Accordingly, the network-specific frequency allocation request entity may be referred to as a second communication node 301 and, in some cases, as a second base station.

The base station 301 may request frequency allocation from a three-dimensional multi-layered network frequency allocation entity 302. The three-dimensional multi-layered network frequency allocation entity 302 may refer to an entity responsible for allocating a frequency channel to each network. The three-dimensional multi-layered network frequency allocation entity 302 may include an operator managing operations of multi-layered networks. The three-dimensional multi-layered network frequency allocation entity 302 may include a Spectrum Authority (SA). The three-dimensional multi-layered network frequency allocation entity may be referred to as a first communication node 302, which may, in turn, be referred to as a first base station or authority.

The second communication node 301 may transmit channel allocation request information requesting allocation of available channel(s) (S310). The second communication node 301 may also transmit system information to the first communication node. The second communication node 301 may transmit the channel allocation request information requesting allocation of available channel(s) to the first communication node based on traffic requirements of the corresponding constituent network over a certain period. Meanwhile, the system information may include details that enable interference analysis between constituent networks. The system information may include at least one of the following: requested channel bandwidth, maximum transmission power, reception sensitivity, locations and communication coverages of transceivers, antenna gain, or channel utilization time.

The first communication node 302 may perform interference analysis based on the system information transmitted by the second communication node (S315). The interference analysis may refer to determining whether interference occurs between the network of the second communication node and other constituent networks using the integrated network's channels. In other words, the first communication node 302 may perform interference analysis between the network of the second communication node and the networks of existing communication nodes using channel resources of the first communication node, based on the system information transmitted by the second communication node. Additionally, the first communication node 302 may select a channel for the second communication node to use based on the interference analysis (S315).

The first communication node 302 may determine whether to allocate a frequency channel to the second communication node 301 (S320). If there is a channel available for use by the second communication node 301, the first communication node 302 may transmit allocation channel information to the second communication node 301 (S325). The second communication node 301 may receive the allocation channel information transmitted by the first communication node 302. Based on the received allocation channel information, the second communication node 301 may transmit allocation channel response information to the first communication node 302 (S330). The first communication node 302 may receive the allocation channel response information transmitted by the second communication node 301.

When there is no channel available for use by the second communication node 301, the first communication node 302 may transmit allocation rejection reason information to the second communication node 301 (S335). The allocation rejection reasons may include a lack of an available channel during a specific time, a required channel bandwidth being too large, or a transmission power being too high. The second communication node 301 may receive the allocation rejection reason information transmitted by the first communication node 302. The second communication node 301 may update the system information based on the received allocation rejection reason information. The second communication node 301 may again transmit channel allocation request information requesting allocation of available channel(s) (S340). Additionally, the second communication node 301 may transmit either the existing system information or the updated system information to the first communication node 302.

The first communication node 302 may perform the same procedures as before (S315, S320, S325, S330) based on the updated system information. Alternatively, the first communication node 302 may perform the same procedures as before (S315, S320, S325, S330) based on the existing system information (S345, S350, S355, S360).

Meanwhile, the channel allocation procedure in FIG. 3 may also be applied to a decentralized channel allocation scheme. The decentralized channel allocation scheme may refer to a scheme in which the second communication node directly requests available channel(s) selected by the first communication node 302. The first communication node 302 may provide a database of previously used frequency channels to the second communication node 301. The second communication node 301 may directly perform interference analysis between networks, and the second communication node 301 may select available channel(s) through the interference analysis, and request the selected channel(s) from the first communication node 302.

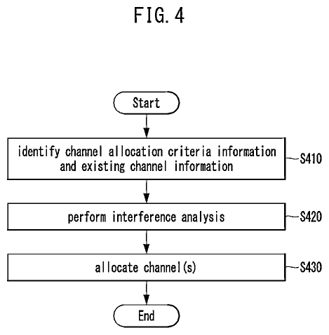

FIG. 4 is a flow chart illustrating an exemplary embodiment of a dynamic channel allocation method.

Referring to FIG. 4, the dynamic channel allocation may be performed by the first communication node.

The first communication node may identify channel allocation criteria (S410). The channel allocation criteria may be defined based on interference tolerance levels. The interference tolerance levels may be composed of three levels of interference tolerance. The first-level interference tolerance may be referred to as a frequency reuse tolerable interference level. The second-level interference tolerance may be referred to as an adjacent channel use tolerable interference level. The third-level interference tolerance may be referred to as a non-adjacent channel use tolerable interference level. The respective levels of interference tolerance may be defined based on thresholds. The three interference tolerance levels may be defined as follows based on thresholds:
Threshold 0: Frequency reuse tolerable interference level
Threshold 1: Adjacent channel use tolerable interference level
Threshold 2: Non-adjacent channel use tolerable interference level

In the present disclosure, the interference tolerance levels may be composed of more than three levels of interference tolerance. For example, four interference tolerance levels may be defined as follows:
Threshold 0: Frequency reuse tolerable interference level
Threshold 1: Adjacent channel use tolerable interference level
Threshold 2: Second adjacent channel use tolerable interference level
Threshold 3: Third or after adjacent channel use tolerable interference level

Meanwhile, interference tolerance levels may be defined in forms such as Undesired/Desired Signal ratio (U/D) values, Signal to Interference plus Noise Ratio (SINR) values, or Interference Noise Ratio (INR) values. The present disclosure may define the interference tolerance levels based on U/D values. The indicators of interference tolerance levels may be referred to as channel allocation criteria information. The channel allocation criteria information may include the thresholds.

The first communication node may identify the channel allocation criteria information and then identify channel information of channels being used by the existing constituent networks (existing communication nodes) (S410). The channel information of the channels used by the existing constituent networks (existing communication nodes) may be referred to as existing channel information. The existing channel information may include at least one of the following: three-dimensional locations of transceivers of the used channels, operating radius and height, channel center frequency, channel bandwidth, maximum transmission power, transmission mask characteristics, required reception SINR, transmission antenna gain, or reception mask characteristics.

The first communication node may perform interference analysis based on the existing channel information (S420). Through the interference analysis, the first communication node may calculate an interference analysis value, which may indicate a U/D value. The first communication node may calculate the U/D values with the existing frequency channels based on the channel allocation criteria information, existing channel information, and system information. The system information refers to the system information provided by the second communication node. The first communication node may perform interference analysis based on the calculated U/D values. When performing the interference analysis, the first communication node may take safety margins into account. To consider the safety margin, the first communication node may identify margin parameter information. The margin parameters may include multipath fading margin, transmission/reception antenna boosting margin, excess path loss margin, shadowing margin, and interference margin.

The first communication node may allocate a channel to the second communication node based on the calculated interference analysis (S430).

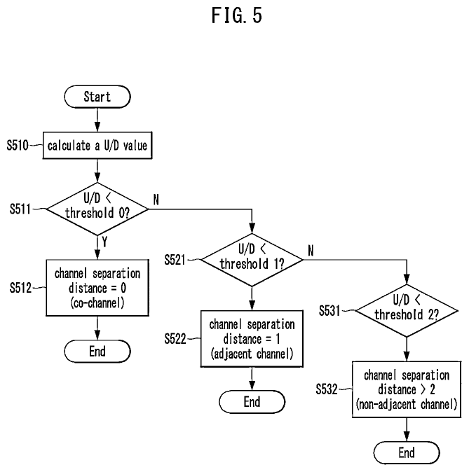

FIG. 5 is a sequence chart illustrating an exemplary embodiment based on a frequency separation distance.

Referring to FIG. 5, a frequency separation distance may be calculated based on a result of the interference analysis. The result of the interference analysis may include the U/D value. The first communication node may acquire the U/D value during the interference analysis process.

The first communication node may calculate the U/D value (S510). To calculate the U/D value, the first communication node may use at least one of the following: channel allocation criteria information, existing channel information, or system information.

The first communication node may determine whether the calculated U/D value is less than the threshold 0 (S511). If the calculated U/D value is less than the threshold 0, the first communication node may determine the channel separation distance to be 0 (S512). The channel separation distance of 0 may mean that the second communication node can reuse the same frequency channel (co-channel) as the one used by the existing communication nodes.

If the calculated U/D value is greater than the threshold 0, the first communication node may determine whether the calculated U/D value is less than the threshold 1 (S521). If the calculated U/D value is less than the threshold 1, the first communication node may determine the channel separation distance to be 1 (S522). The channel separation distance of 1 may indicate that the second communication node cannot reuse the channel being used by the existing communication node. However, the network of the second communication node may use a channel adjacent to the existing channel.

If the calculated U/D value is greater than the threshold 1, the first communication node may determine whether the calculated U/D value is less than the threshold 2 (S531). If the calculated U/D value is less than the threshold 2, the first communication node may determine the channel separation distance to be 2 or greater (S532). The channel separation distance of 2 or greater may indicate that the network of the second communication node cannot reuse the existing channel. However, since the existing channel is non-adjacent to the requested channel, the network of the second communication node may use a non-adjacent channel to the existing channel.

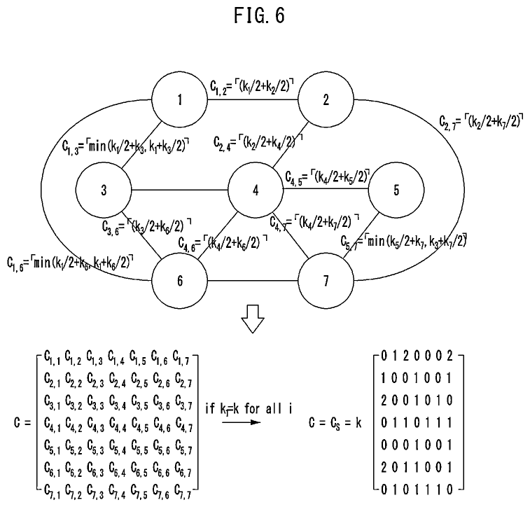

FIG. 6 is a conceptual diagram illustrating an exemplary embodiment of a frequency channel allocation method.

Referring to FIG. 6, the first communication node may perform a frequency channel allocation method to minimize interference between the network of the second communication node and the existing channels. Accordingly, the present disclosure proposes a frequency channel allocation method based on graph coloring.

The method of allocating frequency channels based on graph coloring may refer to a method for finding a channel with minimal coloring. In other words, the frequency channel allocation method based on graph coloring may involve defining a channel as one of co-channel, adjacent channel, or non-adjacent channel, considering adjacent channels. Thus, the method for finding a channel with minimal coloring may be referred to as a method for finding a channel with minimal numbering. In other words, coloring may be referred to as numbering. The number of minimum colorings for existing channels concerning the requested channel may be expressed as shown in Equation 1 below.

$$Minimize = {max}_{e ∈ S , i ∈ X} \{ e \vert {I}_{e , i} = 1 \} \qquad [ Equation 1 ]$$

Here, Minimize may represent the number of minimum colorings (numberings) for existing channels with respect to the requested channel. I_{e,i} may represent an indicator function. Meanwhile, the maximum value of the indicator function for the i-th node may be expressed as shown in Equation 2 below.

$${max}_{e ∈ S} {I}_{e , i} = {m}_{i} for i ∈ X \qquad [ Equation 2 ]$$

The maximum value of the indicator function for the i-th node may be expressed as mi.

Meanwhile, a value obtained by dividing a frequency separation distance between the i-th node and the j-th node by a minimum unit bandwidth may be expressed as shown in Equation 3 below.

$$\vert {n}_{start} ( e ) - {n}_{start} ( n ) \vert \geq {C}_{i , j} for all e , n ∈ S and i , j ∈ X \qquad [ Equation 3 ]$$

When the minimum unit of bandwidth for channel allocation and channel separation is denoted as B, the allocated bandwidth may be represented as kᵢ×B. The frequency separation distance may be expressed as C_{i,j}×B.

C_{i,j} may denote a value obtained by dividing the minimum required frequency separation distance between the i-th node and the j-th node by the minimum unit bandwidth. kᵢ may represent a value obtained by dividing the required channel bandwidth size at the i-th node by the minimum unit bandwidth. In FIG. 6, circular shapes may represent nodes, and each node may include a number indicating a user requesting channel allocation. The connecting lines between nodes may indicate that frequency separation is required due to interference between the nodes. The absence of a connection between nodes indicates no interference. Therefore, if there is no interference between nodes, C_{i,j} corresponding to the nodes may be set to 0 in a matrix.

For example, considering a node 1 as a reference, the node 1 may have connections with nodes 2 and 3, while there may be no connections with nodes 4 to 6. Therefore, C_{1,4} through C_{1,6} may have a value of 0.

C_{1,2} and C_{1,3} may indicate interference between the nodes. Frequency separation may be required to avoid the effects of mutual interference for C_{1,2} and C_{1,3}. For example, a U/D value for the nodes 1 and 2 may be compared with thresholds. If the U/D value is smaller than the threshold 1 but greater than the threshold 2, the frequency separation distance may be calculated using

$${C}_{1 , 2} = ceiling ( min ( \frac{{k}_{1}}{2} , \frac{{k}_{2}}{2} ) ) .$$

If the required channel bandwidths at both the node 1 and node 2 are B, k₁ and k₂ may have a value of 1. C_{1,2} may have a value of 1. ceiling (x) may denote the smallest integer greater than or equal to x.

In the case of the node 1 and node 3, a U/D value for the node 1 and node 3 may be smaller than the threshold 2. If the U/D value for the node 1 and node 3 is smaller than the threshold 2, the separation distance may be calculated using

$${C}_{1 , 3} = ceiling ( min ( \frac{{k}_{1}}{2} + {k}_{3} , {k}_{1} + \frac{{k}_{3}}{2} ) ) .$$

If the required channel bandwidth at the node 3 is B, k₁ and k₃ may have a value of 1. Therefore, C_{1,3} may have a value of 2.

Since C_{i,j} is not interference between nodes, it may always have a value of 0.

Meanwhile, the indicator function may be expressed as shown in Equation 4.

$${I}_{e , i} = 0 or 1 for all e ∈ S and i ∈ X \qquad [ Equation 4 ]$$

When a frequency resource is allocated to the i-th channel, I_{e,i} may be represented as 1. When a frequency resource is not allocated to the i-th channel, I_{e,i} may be represented as 0. X may refer to a set of system indexes. i may indicate a row in the matrix, and i may also represent the i-th network. Similarly, j may indicate a column in the matrix, and j may represent the j-th network. C_{i,j} may represent the frequency separation distance between the i-th network and the j-th network. S may represent a set of channel indexes.

Meanwhile, the channel allocation method based on graph coloring may have high implementation complexity. Therefore, the present disclosure proposes a channel allocation method based on vertical frequency division as a channel allocation method with lower implementation complexity.

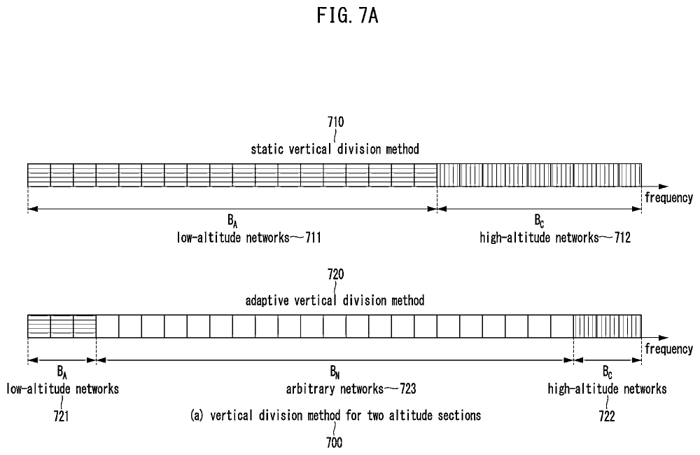

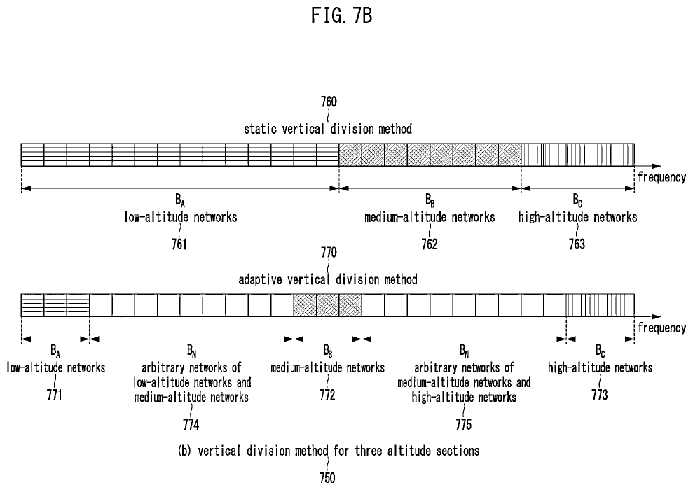

FIG. 7A is a conceptual diagram illustrating a first exemplary embodiment of a vertical division-based channel allocation method.

Referring to FIG. 7A, networks with differences in the locations of transceivers in communication nodes may utilize orthogonally divided frequencies. The orthogonal frequency division may improve frequency usage efficiency. In non-terrestrial networks, new and existing channels may reuse frequencies. To reuse frequencies in the non-terrestrial networks, a spatial separation between two networks may be utilized. If the spatial separation between two networks is greater than a radio horizon, frequencies can be reused. Thus, the spatial separation distance that allows frequency reuse may be determined by a network with a higher transceiver location among the two networks.

For example, when two GEO satellites reuse a specific frequency in the non-terrestrial network, a spatial separation distance for frequency reuse may be determined based on a radio horizon of the network using the GEO satellites. When two LEO satellites reuse a specific frequency in the non-terrestrial network, a spatial separation distance for frequency reuse may be determined based on a radio horizon of the network using the LEO satellites.

If there is a significant difference in the transceiver locations of communication nodes, the spatial separation distance between the networks of the communication nodes may increase for frequency reuse. However, when the spatial separation distance increases, frequency usage efficiency may decrease. Therefore, when there is a significant difference in the transceiver locations of communication nodes, dividing frequencies between the networks of the communication nodes may improve frequency usage efficiency.

FIG. 7A may illustrate a frequency division method when the transceiver locations of communication nodes are classified into two categories. For example, the present disclosure may assume a multi-layer integrated network consisting of LEO satellites and GEO satellites.

A vertical frequency division method may be broadly categorized into a method of statically dividing vertical frequencies and a method of adaptively dividing vertical frequencies. The method of statically dividing vertical frequencies may be referred to as a static vertical division method. The method of adaptively dividing vertical frequencies may be referred to as an adaptive vertical division method.

The static vertical division method may divide the entire frequency resources statically based on a capacity ratio of each altitude-specific network's required capacity to the total network capacity. Within frequency channels 711 and 712 divided for the respective altitudes, only networks corresponding to the respective altitudes may perform interference analysis. The allocation entity may employ channel allocation methods such as frequency reuse, adjacent channel use, or non-adjacent channel use based on the interference analysis.

The static vertical division method may not consider interference analysis and frequency reuse for networks at other altitudes. However, the static vertical division method may have difficulty in reflecting real-time capacity requirements of networks at each altitude, making it challenging to use frequency resources efficiently. For example, at certain times, the number of channels required by networks at lower altitudes may exceed the fixed number of frequency channels allocated for low-altitude networks. In this case, even if the number of channels required by networks at higher altitudes is smaller than the fixed number of frequency channels allocated for higher-altitude networks, the low-altitude networks may not be able to utilize the channels allocated to the higher-altitude networks. Consequently, frequency utilization efficiency may decrease.

To address this issue, the present disclosure proposes an adaptive vertical division method. The adaptive vertical division method may allocate specific frequency resources exclusively for networks at each altitude. The remaining unallocated frequency resources 723 may serve as neutral frequency resources. The neutral frequency resources may be variably used by an arbitrary network as needed.

FIG. 7B is a conceptual diagram illustrating a second exemplary embodiment of a vertical division-based channel allocation method.

FIG. 7B may illustrate a frequency division method when the transceiver locations of communication nodes are classified into three categories. For example, the present disclosure may assume a multi-layer integrated network consisting of LEO satellites, MEO satellites, and GEO satellites.

Meanwhile, while the present disclosure addresses two or three categories as shown in FIGS. 7A and 7B, the same approach may be applied to scenarios using four or more categories.

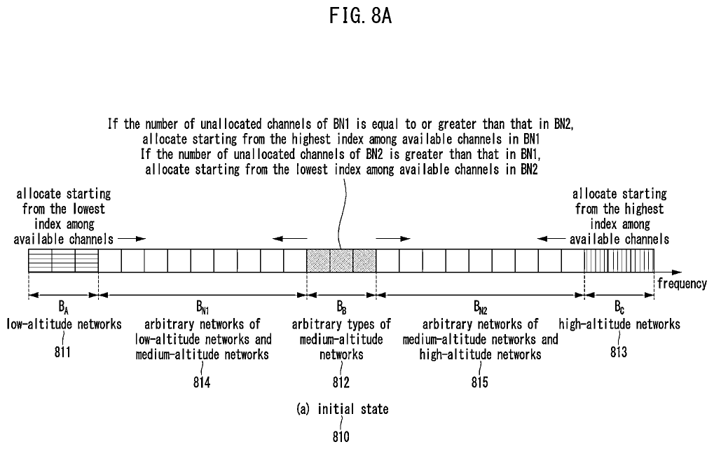

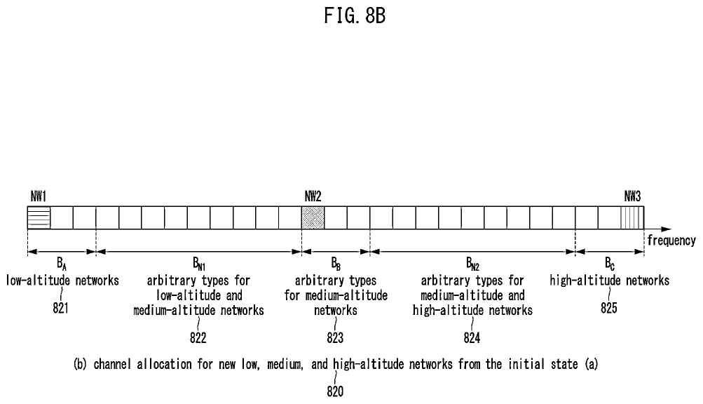

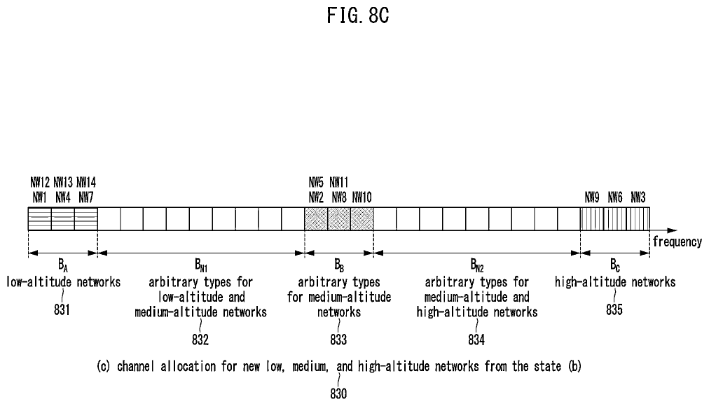

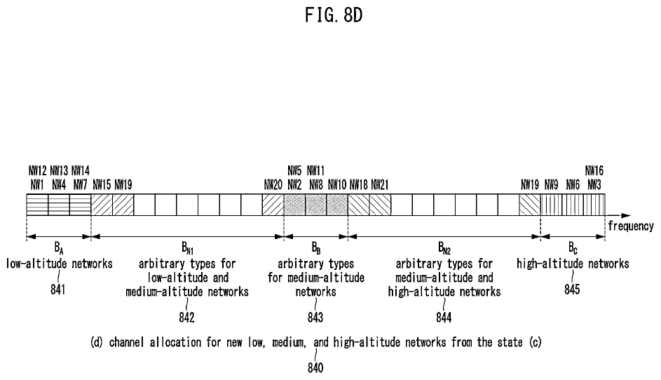

FIG. 8A is a conceptual diagram illustrating a third exemplary embodiment of a vertical division-based channel allocation method.

Referring to FIG. 8A, a method of using frequency resources when there are three vertical categories is illustrated. FIG. 8A may depict a fixed division of B_{A}, B_{B}, and B_{c} frequency resources from the total frequency resources.

FIG. 8A may represent an initial state of the adaptive frequency division method. The initial state of the adaptive frequency division method may be configured as at least one of B_{A}, B_{B}, B_{c}, B_{N1}, or B_{N2} resource section. The B_{A} resource section may represent a frequency channel resource section allocated to low-altitude networks. The B_{A} resource section may represent a frequency channel resource section statically allocated to low-altitude networks and may include three frequency channel resources. The B_{A} resource section 811 may represent allocation of three frequency resources to the low-altitude network. The B_{B} resource section 812 may represent allocation of three frequency resources to the medium-altitude network. The B_{c} resource section 813 may represent allocation of three frequency resources to the higher-altitude network. B_{N1} resources may represent the number of neutral resources that can be freely used by both low-altitude and medium-altitude networks. Similarly, B_{N2} resources may represent the number of neutral resources that can be freely used by both medium-altitude and higher-altitude networks.

The B_{A} resource section 811 may be allocated starting from a channel with the lowest index among the available channels. A channel with a low index refers to a frequency channel resource with a smaller index value, as depicted on the left-hand side of FIG. 8A.

The B_{B} resource section 812 may be allocated based on the number of channels in the B_{N1} and B_{N2} resource sections. If the number of unallocated channels in the B_{N1} resource section is greater than that in the B_{N2} resource section, the first communication node may allocate a channel resource with the highest index available in the B_{N1} resource section. If the number of unallocated channels in the B_{N1} resource section is equal to the number of unallocated channels in the B_{N2} resource section, the first communication node may allocate a channel resource with the highest index available in the B_{N1} resource section. If the number of unallocated channels in the B_{N2} resource section is greater than the number of unallocated channels in the B_{N1} resource section, the first communication node may allocate a channel resource with the lowest index available in the B_{N2} resource section.

The B_{c} resource section 813 may be allocated starting from a channel with the highest index among the available channels. A channel with a high index refers to a frequency channel resource with a larger index value, as depicted on the right-hand side of FIG. 8A.

FIG. 8B is a conceptual diagram illustrating a fourth exemplary embodiment of a vertical division-based channel allocation method.

Referring to FIG. 8B, a method of allocating channels to networks based on altitude is illustrated.

NW1 may denote a low-altitude network. NW1 may request a channel from the allocation entity. The allocation entity may receive channel allocation criteria information. Additionally, the allocation entity may receive information on channels currently being used within resources corresponding to the B_{A} resource section.

FIG. 8C is a conceptual diagram illustrating a fifth exemplary embodiment of a vertical division-based channel allocation method.

Referring to FIG. 8C, an order in which the first communication node allocates frequency channel resources to second communication nodes is illustrated.

If the second communication node belongs to a low-altitude network NW1, the second communication node may request a channel from the first communication node. The first communication node may identify channel allocation criteria and information on channels currently being used in the B_{A} resource section. Since there are no channels currently being used in the B_{A} resource section, the second communication node may utilize all resources in the B_{A} section. The first communication node may allocate a frequency channel resource with the lowest index value in the B_{A} resource section to the second communication node belonging to NW1.

The frequency channel with the lowest numbering in the B_{A} resource section may refer to the channel with the lowest index value in the B_{A} resource section. Therefore, the frequency channel with the lowest index value in the B_{A} resource section may refer to a channel resource located on the far left of the B_{A} resource section.

If the second communication node belongs to a medium-altitude network NW2, the second communication node may request a channel from the first communication node. The first communication node may identify channel allocation criteria and information on channels currently being used in the B_{B} resource section. Since there are no channels currently being used in the B_{B} resource section, the second communication node may utilize all resources in the B_{B} resource section. The first communication node may allocate a resource with the lowest index value in the B_{B} resource section to the second communication node.

The frequency channel with the lowest numbering in the B_{B} resource section may refer to the channel with the lowest index value in the B_{B} resource section. Therefore, the frequency channel with the lowest index value in the B_{B} resource section may refer to a channel resource located on the far left of the B_{B} resource section.

If the second communication node belongs to a high-altitude network NW3, the second communication node may request a channel from the first communication node. The first communication node may identify channel allocation criteria and information on channels currently being used in the B_{c} resource section. Since there are no channels currently being used in the B_{c} resource section, the second communication node may utilize all resources in the B_{c} resource section. The first communication node may allocate a frequency channel resource with the highest index value in the B_{c} resource section to the second communication node belonging to NW3.

The frequency channel with the highest index value in the B_{c} resource section may refer to the channel with the highest index value in the B_{c} resource section. Therefore, the frequency channel with the highest index value in the B_{c} resource section may refer to a channel resource located on the far right of the B_{c} resource section.

If the second communication node belongs to a low-altitude network NW4, the second communication node may request a channel from the first communication node. The first communication node may identify channel allocation criteria and information on channels being used in the B_{A} resource section. Since there are channels in use within the B_{A} resource section, the first communication node may perform interference analysis between NW1 and NW4. Based on the interference analysis, if a channel separation distance is 1, the second communication node at NW4 may confirm that it can use an adjacent channel of NW1. The first communication node may allocate a resource (i.e. adjacent channel of NW1) with the lowest index value among available resources in the B_{A} resource section to the second communication node at NW4.

If the second communication node belongs to a medium-altitude network NW5, the second communication node may request a channel from the first communication node. The first communication node may identify channel allocation criteria and information on channels being used in the B_{B} resource section. Since there are channels in use within the B_{B} resource section, the first communication node may perform interference analysis between NW2 and NW5. Based on the interference analysis, if a channel separation distance is 0, the second communication node at NW5 may confirm that it can reuse a frequency of NW2. The first communication node may allocate a resource (i.e. co-channel with NW2) with the lowest index value among available resources in the B_{B} resource section to the second communication node at NW5.

If the second communication node belongs to a high-altitude network NW6, the second communication node may request a channel from the first communication node. The first communication node may identify channel allocation criteria and information on channels being used in the B_{c} resource section. Since there are channels in use within the B_{c} resource section, the first communication node may perform interference analysis between NW3 and NW6. Based on the interference analysis, if a separation distance is 1, the second communication node at NW6 may confirm that it can use an adjacent channel of NW3. The first communication node may allocate a resource (i.e. adjacent channel of NW3) with the highest index value among the available resources in the B_{c} resource section to the second communication node at NW6.

If the second communication node belongs to a low-altitude network NW7, the second communication node may request a channel from the first communication node. The first communication node may identify channel allocation criteria and information on channels being used in the B_{A} resource section. Since there are channels in use within the B_{A} resource section, the first communication node may perform interference analysis among NW1, NW4, and NW7. Based on the interference analysis, if channel separation distances are all 1, the second communication node at NW7 may confirm that it can use adjacent channels of NW1 and NW4. The first communication node may allocate a resource (i.e. adjacent channel of NW4) with the lowest index value among available resources in the B_{A} resource section to the second communication node at NW7.

If the second communication node belongs to a medium-altitude network NW8, the second communication node may request a channel from the first communication node. The first communication node may identify channel allocation criteria and information on channels being used in the B_{B} resource section. Since there are channels in use within the B_{B} resource section, the first communication node may perform interference analysis among NW2, NW5, and NW8. Based on the interference analysis, if a separation distance from NW2 is 0 and a separation distance from NW5 is 1, the second communication node at NW8 may confirm that it can reuse a frequency resource of NW2 and can use an adjacent channel of NW5. The first communication node may allocate a resource (i.e. adjacent channel of NW5) with the lowest index value among available resources in the B_{B} resource section to the second communication node NW8.

If the second communication node belongs to a high-altitude network NW9, the second communication node may request a channel from the first communication node. The first communication node may identify channel allocation criteria and information on channels being used in the B_{c} resource section. Since there are channels in use within the B_{c} resource section, the first communication node may perform interference analysis among NW3, NW6, and NW9. Based on the interference analysis, if a separation distance from NW3 is 2 or more and a separation distance from NW6 is 1, the second communication node at NW9 may confirm that it can use a non-adjacent channel of NW3 and reuse a frequency resource of NW6. The first communication node may allocate a resource (i.e. adjacent channel of NW9) with the highest index value among available resources in the B_{c} resource section to the second communication node at NW9.

If the second communication node belongs to a medium-altitude network NW10, the second communication node may request a channel from the first communication node. The first communication node may identify channel allocation criteria and information on channels being used in the B_{B} resource section. Since there are channels in use within the B_{B} resource section, the first communication node may perform interference analysis among NW2, NW5, NW8, and NW10. Based on the interference analysis, if a separation distance from NW2 is 0, a separation distance from NW5 is 1, and a separation distance from NW8 is 1, the second communication node at NW10 may confirm that it can reuse a frequency resource of NW2, can use an adjacent channel of NW5, and can use an adjacent channel of NW8. The first communication node may allocate a resource (i.e. adjacent channel of NW8) with the lowest index value among available resources in the B_{B} resource section to the second communication node NW10.

FIG. 8D is a conceptual diagram illustrating a sixth exemplary embodiment of a vertical division-based channel allocation method.

Referring to FIG. 8D, a method of allocating a frequency channel resource in the B_{N1} or B_{N2} resource section is illustrated.

For example, if the second communication node belongs to a low-altitude network NW15, the second communication may request a channel from the first communication node. The first communication node may identify channel allocation criteria and information on channels being used in the B_{A} resource section. Since there are channels in use within the B_{A} resource section, the first communication node may perform interference analysis among NW1, NW4, NW7, NW12, NW13, NW14, and NW15. Based on the interference analysis, if separation distances from NW1, NW4, and NW7 are all 1, a separation distance from NW13 is greater than 2, and separation distances from NW12 and NW14 are 0, the second communication node at NW15 may confirm that it can use adjacent channels of NW1, NW4, NW7, NW12, NW13, and NW14, can use a non-adjacent channel of NW13, and can reuse frequencies of NW12 and NW14. Consequently, the first communication node may confirm that there are no available resources in the B_{A} resource section. Therefore, the first communication node may allocate a resource with the lowest index value among available resources in the B_{B} resource section to the second communication node at NW15 (i.e. a channel with the lowest index value in B_{N1}).

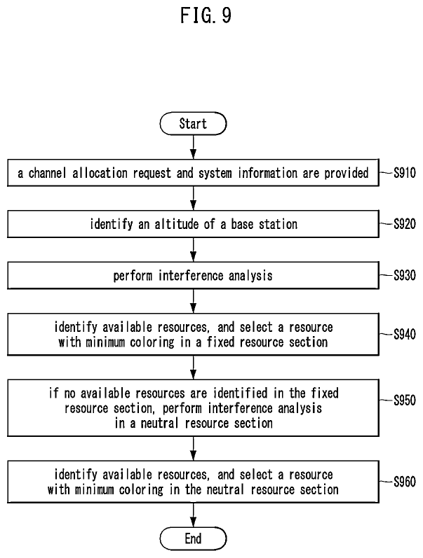

FIG. 9 is a flowchart illustrating a first exemplary embodiment of a vertical division method.

Referring to FIG. 9, a frequency channel allocation method is illustrated.

The second communication node may request channel allocation from the first communication node (S910). Additionally, the second communication node may transmit system information to the first communication node. The first communication node may determine an altitude of the second communication node based on the system information (S920). The first communication node may classify the second communication node by altitude based on the determined altitude. The first communication node may perform interference analysis (S930). The interference analysis may be performed between a network of the second communication node and networks of existing communication nodes at the same altitude as the second communication node that are using the first communication node's channel resources. Through the interference analysis, the first communication node may identify frequency channel resources available for use by the second communication node. In this case, the first communication node may consider the altitude of the second communication node. Furthermore, the frequency channel resources identified by the first communication node may be frequency channel resources correspond to a fixed resource section. The first communication node may select a frequency channel resource with the lowest index value among the frequency channel resources available to the second communication node (S940).

If there are no available resources in the fixed resource section, the first communication node may perform interference analysis in a neutral resource section (S950). The first communication node may perform interference analysis between the network of the second communication node and the networks of existing communication nodes (S950). Through the interference analysis, the first communication node may identify available frequency channel resources in the neutral resource section that the second communication node can use (S960). The first communication node may select a frequency channel resource with the lowest index value among the available frequency channel resources in the neutral resource section.

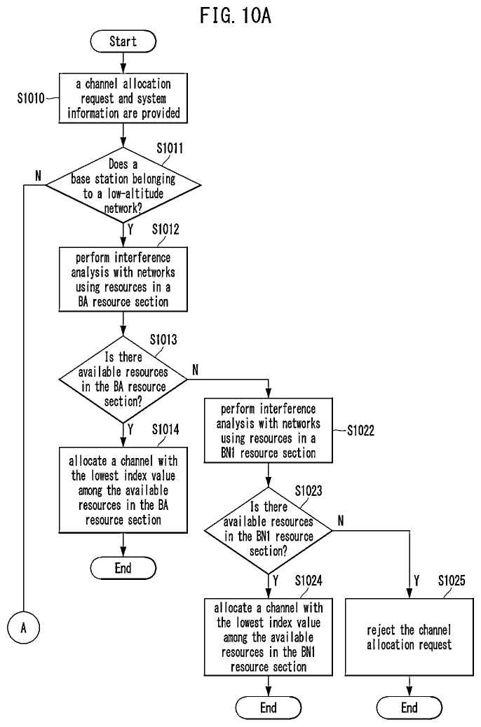

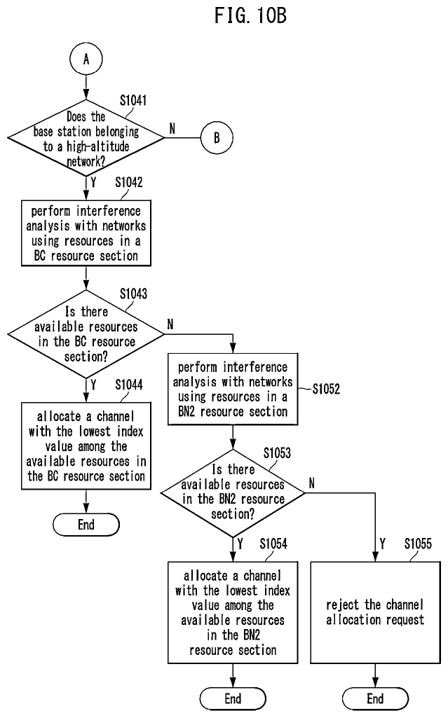

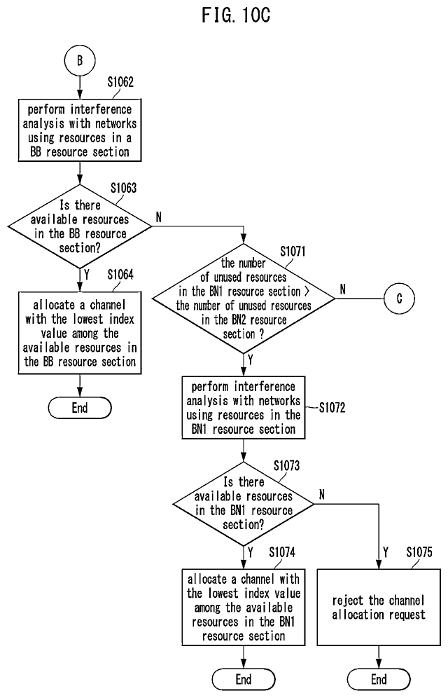

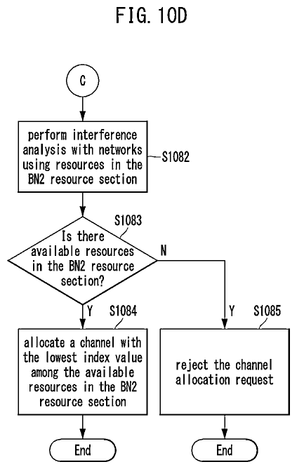

FIG. 10A is a flowchart illustrating a second exemplary embodiment of a vertical division method.

Referring to FIG. 10A, a vertical frequency division method is illustrated.

The second communication node may transmit a channel allocation request to the first communication node (S1010). Additionally, the second communication node may transmit system information of itself to the first communication node. The first communication node may receive the system information of the second communication node. Based on the system information, the first communication node may determine whether a network altitude of the second communication node corresponds to a low-altitude network (S1011). If the network altitude of the second communication node corresponds to a low-altitude network, the first communication node may perform interference analysis (S1012). The first communication node may perform interference analysis between the network of the second communication node and networks of existing communication nodes using frequency channel resources in the B_{A} resource section. The B_{A} resource section may include frequency channel resources allocated to low-altitude networks. The first communication node may determine whether there are resources in the B_{A} resource section that the network of the second communication node can use (S1013). If resources exist in the B_{A} resource section that the second communication node's network can use, the first communication node may allocate a frequency channel resource with the lowest index value among the available resources (S1014). If resources do not exist in the B_{A} resource section that the second communication node's network can use, the first communication node may perform interference analysis in the B_{N1} resource section (S1022). The first communication node may perform interference analysis between the network of the second communication node and networks of existing communication nodes using frequency channel resources in the B_{N1} resource section. The first communication node may determine whether there are resources in the B_{N1} resource section that the second communication node's network can use (S1023). If resources exist in the B_{N1} resource section that the second communication node's network can use, the first communication node may allocate a frequency channel resource with the lowest index among the available resources (S1024). If resources do not exist in the B_{N1} resource section that the second communication node's network can use, the first communication node may reject the channel allocation request (S1025).

FIG. 10B is a flowchart illustrating a third exemplary embodiment of a vertical division method.

Referring to FIG. 10B, a vertical frequency division method is illustrated.

The first communication node may determine whether a network altitude of the second communication node corresponds to a high-altitude network based on the system information of the second communication node (S1041). If the network altitude of the second communication node corresponds to a high-altitude network, the first communication node may perform interference analysis (S1042). The first communication node may perform interference analysis between the network of the second communication node and the networks of existing communication nodes using frequency channel resources in the B_{c} resource section. The B_{c} resource section may include frequency channel resources allocated to high-altitude networks. The first communication node may determine whether there are resources in the B_{c} resource section that the network of the second communication node can use (S1043). If resources exist in the B_{c} resource section that the second communication node's network can use, the first communication node may allocate a frequency channel resource with the lowest index value among the available resources (S1044). If resources do not exist in the B_{c} resource section that the second communication node's network can use, the first communication node may perform interference analysis in the B_{N2} resource section (S1052). The first communication node may perform interference analysis between the network of the second communication node and the networks of existing communication nodes using frequency channel resources in the B_{N2} resource section. The first communication node may determine whether there are resources in the B_{N2} resource section that the second communication node's network can use (S1053). If resources exist in the B_{N2} resource section that the second communication node's network can use, the first communication node may allocate a frequency channel resource with the lowest index value among the available resources (S1054). If resources do not exist in the B_{N2} resource section that the second communication node's network can use, the first communication node may reject the channel allocation request (S1055).

FIG. 10C is a flowchart illustrating a fourth exemplary embodiment of a vertical division method.

Referring to FIG. 10C, a vertical frequency division method is illustrated.

If a network altitude of the second communication node does not correspond to a high-altitude, the first communication node may perform interference analysis (S1062). The first communication node may perform interference analysis between the network of the second communication node and the networks of existing communication nodes using frequency channel resources in the B_{B} resource section. The B_{B} resource section may include frequency channel resources allocated to medium-altitude networks. The first communication node may determine whether there are resources in the B_{B} resource section that the network of the second communication node can use (S1063). If resources exist in the B_{B} resource section that the second communication node's network can use, the first communication node may allocate a frequency channel resource with the lowest index value among the available resources (S1064). If resources do not exist in the B_{B} resource section that the second communication node's network can use, the first communication node may compare the number of unused resources in the B_{N1} resource section with those in the B_{N2} resource section (S1071).

If the number of unused resources in the B_{N1} resource section is greater than the number of unused resources in the B_{N2} resource section, the first communication node may perform interference analysis using the frequency channel resources in the B_{N1} resource section (S1072). The first communication node may perform interference analysis between the network of the second communication node and the networks of existing communication nodes using frequency channel resources in the B_{N1} resource section. The first communication node may determine whether there are resources in the B_{N1} resource section that the network of the second communication node can use (S1073). If resources exist in the B_{N1} resource section that the second communication node's network can use, the first communication node may allocate a frequency channel resource with the lowest index value among the available resources (S1074). If resources do not exist in the B_{N1} resource section that the second communication node's network can use, the first communication node may reject the channel allocation request (S1075).

FIG. 10D is a flowchart illustrating a fifth exemplary embodiment of a vertical division method.

Referring to FIG. 10D, a vertical frequency division method is illustrated.

If the number of unused resources in the B_{N2} resource section is greater than the number of unused resources in the B_{N1} resource section, the first communication node may perform interference analysis using the frequency channel resources in the B_{N2} resource section (S1082). The first communication node may perform interference analysis between the network of the second communication node and the networks of existing communication nodes using the frequency channel resources in the B_{N2} resource section. The first communication node may determine whether there are resources in the B_{N2} resource section that the network of the second communication node can use (S1083). If resources exist in the B_{N2} resource section that the second communication node's network can use, the first communication node may allocate a frequency channel resource with the lowest index value among the available resources (S1084). If resources do not exist in the B_{N2} resource section that the second communication node's network can use, the first communication node may reject the channel allocation request (S1085).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
receiving, from a second communication node, channel request information including information requesting one or more channels available for use by the second communication node and system information of the second communication node;
performing interference analysis based on the channel request information and the system information;
determining the one or more channels available for use by the second communication node based on a result of the interference analysis;
determining a first channel to be allocated to the second communication node among the one or more available channels; and
transmitting channel information including information on the first channel to the second communication node.

2. The method according to claim 1, wherein the performing of the interference analysis comprises: performing the interference analysis by comparing a channel of the second communication node and channels used in a network of the first communication node.

3. The method according to claim 1, wherein the performing of the interference analysis comprises:
calculating an undesired/desired signal ratio (U/D) value based on at least one of the system information of the second communication node, allocation criteria information including threshold(s), and existing channel information including information of channels used in a network of the first communication node;
calculating a separation distance between the channel of the second communication node and the channels used in the network of the first communication node based on the U/D value; and
performing the interference analysis based on the separation distance.

4. The method according to claim 1, wherein the determining of the one or more channels available for use by the second communication node comprises:
classifying channels used in a network of the first communication node into at least one of co-channel, adjacent channel, or non-adjacent channel, respectively, based on the result of the interference analysis; and
determining the one or more channels available for use by the second communication node based on the classified channels.

5. The method according to claim 1, wherein the performing of the interference analysis comprises:
classifying the second communication node according to an altitude of the second communication node based on the system information; and
performing the interference analysis with channels corresponding to the altitude of the second communication node among channels used in a network of the first communication node.

6. The method according to claim 5, wherein the determining of the one or more channels available for use by the second communication node comprises: determining the one or more channels available for use by the second communication node, based on a ratio of a total network capacity of the first communication node to a network capacity corresponding to the altitude.

7. The method according to claim 5, wherein the determining of the one or more channels available for use by the second communication node comprises: determining the one or more channels available for use by the second communication node in a fixed frequency channel resource section of the first communication node, the fixed frequency resource section being classified according to the altitude.

8. The method according to claim 5, wherein the determining of the one or more channels available for the second communication node comprises: determining the one or more channels available for use by the second communication node in a neutral frequency channel resource section of the first communication node, the neutral frequency channel resource section being classified according to the altitude.

9. A method of a second communication node, comprising:
transmitting, to a first communication node, channel request information including information requesting one or more available channels and system information of the second communication node;
receiving, from the first communication node, channel information generated based on the channel request information and the system information of the second communication node; and
transmitting, to the first communication node, channel response information generated based on the channel information.

10. The method according to claim 9, wherein the channel information includes information on one or more channels determined based on a ratio of a total network capacity of the first communication node to a network capacity corresponding to an altitude of the second communication node.

11. The method according to claim 9, wherein the channel information includes information on one or more channels determined based on channels allocated in a fixed frequency resource section of the first communication node.

12. The method according to claim 9, wherein the channel information includes information on one or more channels determined based on channels allocated in a neutral frequency resource section of the first communication node.

13. A first communication node comprising at least one processor, wherein the at least one processor causes the first communication node to perform:
receiving, from a second communication node, channel request information including information requesting one or more channels available for use by the second communication node and system information of the second communication node;
performing interference analysis based on the channel request information and the system information;
determining the one or more channels available for use by the second communication node based on a result of the interference analysis;
determining a first channel to be allocated to the second communication node among the one or more available channels; and
transmitting channel information including information on the first channel to the second communication node.

14. The first communication node according to claim 13, wherein in the performing of the interference analysis, the at least one processor causes the first communication node to perform: performing the interference analysis by comparing a channel of the second communication node and channels used in a network of the first communication node.

15. The first communication node according to claim 13, wherein in the performing of the interference analysis, the at least one processor causes the first communication node to perform:
calculating an undesired/desired signal ratio (U/D) value based on at least one of the system information of the second communication node, allocation criteria information including threshold(s), and existing channel information including information of channels used in a network of the first communication node;
calculating a separation distance between the channel of the second communication node and the channels used in the network of the first communication node based on the U/D value; and
performing the interference analysis based on the separation distance.

16. The first communication node according to claim 13, wherein in the determining of the one or more channels available for use by the second communication node, the at least one processor causes the first communication node to perform:
classifying channels used in a network of the first communication node into at least one of co-channel, adjacent channel, or non-adjacent channel, respectively, based on the result of the interference analysis; and
determining the one or more channels available for use by the second communication node based on the classified channels.

17. The first communication node according to claim 13, wherein in the performing of the interference analysis, the at least one processor causes the first communication node to perform:
classifying the second communication node according to an altitude of the second communication node based on the system information; and
performing the interference analysis with channels corresponding to the altitude of the second communication node among channels used in a network of the first communication node.

18. The first communication node according to claim 17, wherein in the determining of the one or more channels available for use by the second communication node, the at least one processor causes the first communication node to perform: determining the one or more channels available for use by the second communication node, based on a ratio of a total network capacity of the first communication node to a network capacity corresponding to the altitude.

19. The first communication node according to claim 17, wherein in the determining of the one or more channels available for use by the second communication node, the at least one processor causes the first communication node to perform: determining the one or more channels available for use by the second communication node in a fixed frequency channel resource section of the first communication node, the fixed frequency resource section being classified according to the altitude.

20. The first communication node according to claim 17, wherein in the determining of the one or more channels available for use by the second communication node, the at least one processor causes the first communication node to perform: determining the one or more channels available for use by the second communication node in a neutral frequency channel resource section of the first communication node, the neutral frequency channel resource section being classified according to the altitude.
